(19) United States
(12) Patent Application Publication
(10) Pub. No.: US 2006/0113133 A1
(43) Pub. Date: Jun. 1, 2006

(54) Vent assembly for a motorcycle fairing

(75) Inventors: Mehmed Berkovic, Roanoke, VA (US); Whitwell C. Kelly, Salem, VA (US)

Correspondence Address: DORITY & MANNING, P.A., POST OFFICE BOX 1449, GREENVILLE, SC, 29602-1449, US

(73) Assignee: SALEM VENT INTERNATIONAL, INC.

(21) Appl. No.: 11/001,677

(22) Filed: Dec. 1, 2004

(51) Int. Cl. B62K 11/00

(52) U.S. Cl. 180/219

(57) ABSTRACT

A wing extension assembly for a motorcycle fairing includes a base member having an attachment edge with a shape for complimentary attachment along an edge of the motorcycle faring. A vent assembly is configured in the base member. The vent assembly is manually positionable between a closed position wherein airflow through the vent assembly is blocked, and an open position wherein airflow is directed through the vent assembly. The invention includes any manner of motorcycle fairing utilizing a pair of the wing extensions.

### BACKGROUND

Various types of motorcycles are equipped with an aerodynamic fairing below the windshield as original equipment, or as an aftermarket item. Fairings serve multiple purposes, including reducing drag, protecting the rider, wind deflector, and improving the aesthetics and styling of the bike.

As far as functioning as a wind deflector, conventional windshield fairings are sized to protect, to a certain extent, the rider's midsection and hand area from excessive wind, yet are not designed to encompass the area in front of the rider's upper thighs. Lower fairings are available that mount to the bike generally below the headlight assembly and are configured to protect the rider's thighs and legs. These lower fairings deflect substantially all wind away from the rider's lower torso.

However, a certain amount of wind and air circulation is desired in certain situations, particularly in warmer climates. Thus, conventional fairings (particularly windshield fairings) are generally sized as a compromise between deflecting wind yet allowing a certain amount of circulation and airflow past the rider. In this regard, conventional fairings tend to have a substantially tapered design from the bottom edge of the windshield and handlebars (particularly at the handgrips) towards the headlamp assembly.

Today's riders travel long distances and through diverse weather and climate conditions. This is particularly true with touring bike enthusiasts. In colder climates, many of these riders prefer a fairing with wider dimensions in the area below the handlebars to provide increased protection against cold airflow. However, the same riders may not want this increased protection in warmer climates, and prefer a smaller fairing under such conditions.

Recognizing this dilemma, certain bike manufacturers offer fairing extensions or “wings” that can be removably attached along the edges of the permanent fairing when needed. The wings are readily removed and stored, for example in pouches or the bike's saddlebags, when not needed. Attachment holes are provided along the edges of the fairing, and the wings are attached by wing nuts or other suitable means. Although this configuration offers a partial solution, it is still inconvenient and time consuming for a rider to attach or remove the wings, particularly in the middle of a trip. Also, the wings are easily lost or misplaced once removed.

In this regard, the industry is in need of a fairing that offers the benefits of larger dimensions in certain environments, and smaller dimensions when increased airflow is desired. The present invention satisfies this need.

### SUMMARY

Various features and advantages of the invention will be set forth in the following description, or may be obvious from the description, or may be learned through practice of the invention.

In accordance with aspects of the invention, a vented extension or “wing” assembly is provided for a motorcycle fairing. Although the wing extensions have particular utility as windshield fairing extensions, it should be appreciated that the wing extensions according to the invention may be used with type and configuration of fairing wherein it is desired to extend the dimensions of the fairing yet allow airflow through the extended portion.

In use, a pair of the wings are provided and attached to opposite lateral side edges of the fairing. The wing assembly includes a base member having an attachment edge that is shaped for complimentary attachment along an edge of the faring. For example, the attachment edge may have the same curvature as the edge of the fairing to which it is to be attached. The base member may be made of any suitable material, for example from the same material as the fairing or windshield, and may be clear or any desired color.

The base member may be attached to the fairing by any conventional attachment mechanism. In a particular embodiment, the vented wing assembly is releasably attached to the fairing. For example, the base member may be bolted to the fairing with use of wing nuts. Other mechanical quick-release devices may be utilized as well. In an alternate embodiment, the wing assembly may be permanently attached to the fairing, for example by riveting, adhesive, welding, and so forth.

A vent assembly is provided as an integral component of the base member, and is configured to be manually positioned between a closed position wherein airflow through the vent assembly is essentially blocked, and an open position wherein airflow is directed through the vent assembly. It should be appreciated that the vent assembly may be variously configured within the scope and spirit of the invention to provide a vent passage that is readily opened and closed by the rider as needed. In a particular embodiment, the vent assembly includes a vent passage through the base member, and a cover member movably mounted to the base member so as to be positionable by the rider between a closed position and open position. The vent passage may comprise any pattern of opening(s) through the base member. For example, the passage may include a series of elongated parallel openings, or a grid pattern of openings, or a single opening through the base member. The cover member is designed to compliment the vent passage such that the passage is blocked by the cover member in the closed position, and at least partially open to air flow in an open position of the cover member.

In one particular embodiment, the cover member is rotatably mounted to the base member and is thus rotated between the open and closed positions. The cover member may be rotatably mounted relative to an axis located at the center of the vent passage. In an alternate embodiment, the cover member may be linearly slidable relative to the base member.

The cover member may take on various configurations. For example, the cover member may include a series of spaced ribs that cover the vent passage openings in the closed position, and move to a position to at least partially uncover the openings in the open position of the cover member. The ribs may be symmetrically offset with respect to the openings in the base member such that in the open position of the cover member, the ribs are between the openings and aligned in the same direction as the openings. In the closed position, the cover member is rotated such that ribs are disposed over and aligned with the openings in the base member. In an alternate configuration, the ribs may be generally transverse to the vent passage openings in the open position such that a grid pattern is defined by the openings in the base member and the ribs in the cover member. The ribs may have an upper angled component such that the direction of airflow through the vent passage is varied by the rotational position of the cover member.

In a desirable embodiment, the vent assembly is variably positionable between its closed and open positions such that airflow through the vent passage may be varied between a full volume and substantially zero volume. In the embodiment of a rotational cover member, the closed and open rotational positions of the cover member may be defined by structural stops that prevent further rotation of the cover member in a given direction. The cover member may be variably positionable between these stops. For example, the cover member may be rotationally slidable relative to the base member by way of a frictional engagement that is sufficient to maintain the cover member in any desired rotational position between the stops. In an alternate embodiment, the cover member may be variably positionable between defined positions by way defined mechanical stop positions. For example the circumferential edge of the cover member may include recesses that are engaged by structure on the base member, such as the stops, whereby the recesses define individual rotational positions of the cover member.

It is desirable that the cover member be easily movable by the rider. In this regard, a finger grip member may be provided on the cover member to allow for manual grasping and rotation of the cover member.

The invention also encompasses a motorcycle fairing having the vented wing assemblies configured therewith.

Aspects of the invention will be described in greater detail below by reference to embodiments illustrated in the drawings.

### BRIEF DESCRIPTION OF THE DRAWINGS

FIG. 1 is a perspective view of a cover member component of the vent assembly used in an embodiment of the invention;

FIG. 2 is a perspective view of an embodiment of a base member that may be used in an exemplary embodiment with the cover member of FIG. 1;

FIG. 3 is a perspective assembly view of the components of FIGS. 1 and 2;

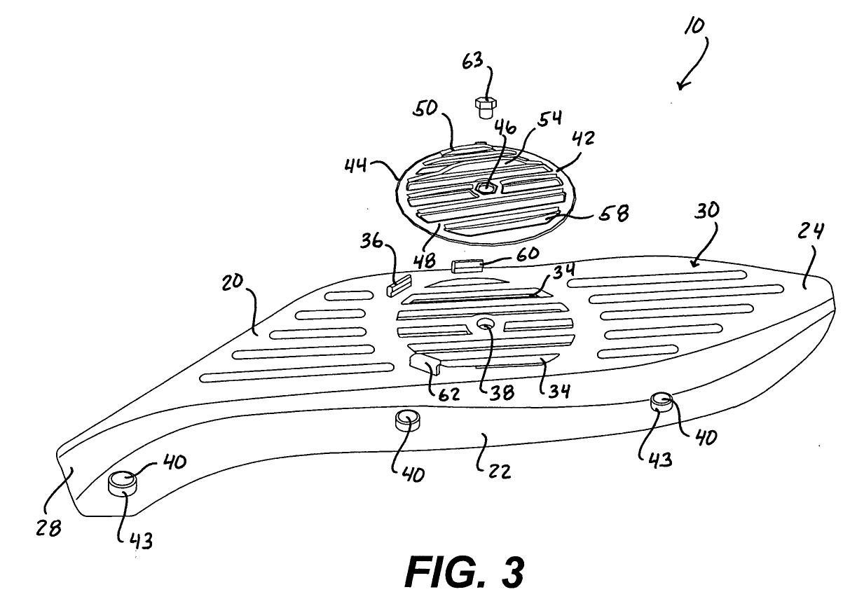

FIG. 4 is a perspective view of an exemplary embodiment of the invention installed on a motorcycle fairing;

FIG. 5 is a perspective view of the embodiment of the vented extension assembly of FIG. 4 in a fully open position of the cover member; and

FIG. 6 is a perspective view of the embodiment of the vented extension assembly of FIG. 4 in a fully closed position of the cover member.

### DETAILED DESCRIPTION

Reference will now be made in detail to one or more embodiments of the invention, examples of which are graphically illustrated in the drawings. The embodiments are provided by way of explanation of the invention, and not meant as a limitation of the invention. For example, features illustrated or described as part of one embodiment may be utilized with another embodiment to yield still a further embodiment. It is intended that the present invention include these and other modifications and variations.

It should be understood that a vented extension assembly according to the invention is not limited to use on any particular type or style of motorcycle fairing, or motorcycle in general. The present invention has utility on all types of motorcycle fairings, and all such uses are within the scope and spirit of the invention.

It should also be appreciated that the present invention includes the vented extension assemblies (“wings”) separate from a fairing, as well as fairings incorporating the wings.

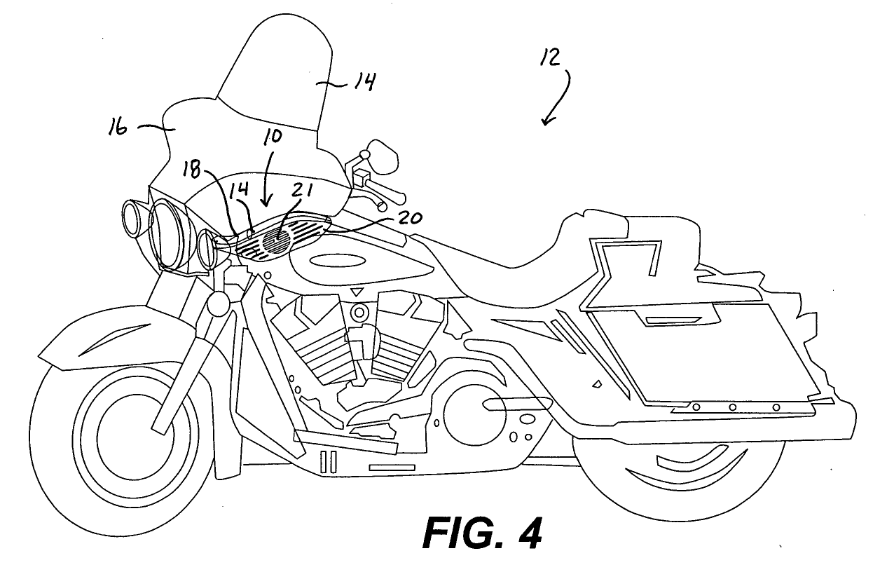

Referring to FIG. 4, in accordance with aspects of the invention, a vented extension assembly 10 or “wing” is provided for attachment to a conventional motorcycle fairing 16 installed on a motorcycle 12 below the bike's windshield 14. The use of fairings 16, their construction, and installation on bikes is well known to those skilled in the art and need not be described in detail herein for an understanding of the vented wing assembly 10. In use, a pair of the wings 10 are provided and attached to opposite side edges 18 of the fairing 16.

Referring to the figures in general, the wing assembly 10 includes a base member 20 having an attachment edge 22 that is shaped for complimentary attachment along the edge 18 of the faring 16, as depicted in FIG. 4. For example, the attachment edge 22 may have the same curvature as the edge 18 of the fairing 16 to which it is to be attached, and may include a ridge 28 against which the edge 18 of the fairing 16 abuts so that the outer face of the fairing 16 and face 24 of the base member 20 are essentially flush. The base member 20 may be made of any suitable material, for example from the same material as the fairing 16 or windshield 14, and may be clear or any desired color. The base member 20 may have any manner of decorative markings or moldings, such as the raised pattern of moldings 30 on face 24 of the base member 20.

The base member 20 may be attached to the fairing 16 by any conventional attachment mechanism, including permanent or releasable devices. In the illustrated embodiment, the vented wing assembly 10 is releasably attached to the fairing 16. For example, the base member 20 may be bolted to the fairing 16 with the use of bolts and wing nuts 41 or other devices inserted through holes 40 in the base member edge 22 that align with correspondingly spaced holes along the edge 18 of the fairing 16. For easy insertion and alignment purposes, the holes 40 may be defined through cylindrical extensions 43 that fit into the holes defined in the fairing edge 18. Other mechanical quick release devices may be utilized as well. In an alternate embodiment, the wing assembly 10 may be permanently attached to the fairing 16, for example by riveting, adhesive, welding, and so forth.

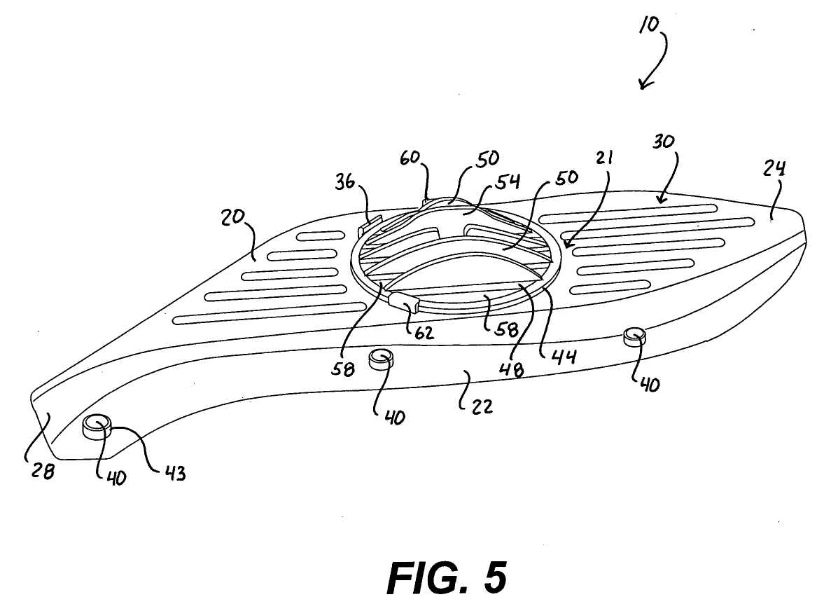

A vent assembly 21 is provided as an integral component of the base member 20, and is configured to be manually positioned between a closed position wherein airflow through the vent assembly 21 is blocked, as shown in FIG. 5, and an open position wherein airflow is directed through the vent assembly 21, as shown in FIG. 5. It should be appreciated that the vent assembly 21 may be variously configured within the scope and spirit of the invention to provide a vent passage that is readily opened and closed by the rider as needed. In the illustrated embodiment, the vent assembly 21 includes a vent passage 32 through the base member 20, and a cover member 42 movably mounted to the base member 20. As described in greater detail below, the cover member 42 is positionable between a closed position wherein the vent passage 32 is blocked to air flow, and an open position wherein the vent passage 32 is open to air flow. The vent passage 32 may comprise any pattern of openings or holes through the base member 22. In the illustrated embodiment, the vent passage 32 is defined by a series of elongated parallel openings or slots 34 through the base member 20. In an alternate embodiment, the vent passage 32 may be a grid pattern of openings, or a single opening through the base member 20.

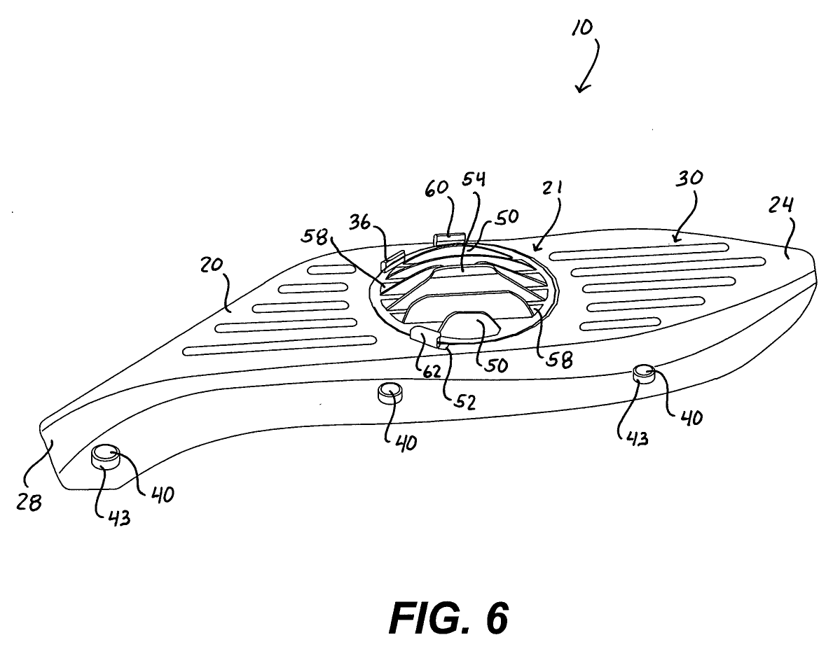

The cover member 42 is designed to compliment the vent passage 32 such that the openings 34 are blocked by structure of the cover member 42 in the closed position, and at least partially open to air flow in an open position of the cover member 42. In the illustrated embodiment, the cover member 42 is rotatably mounted to the base member 20 by way of, for example, an axle 63 through holes 46 and 38 in the center of the cover member 42 and vent passage 32 in the base member 20, respectively, and is thus rotatable between the open position of FIG. 5 and closed position of FIG. 6. In an alternate embodiment, the cover member 42 may be linearly slidable relative to the base member so as to cover the vent passage openings 34 in one linear position, and be displaced from the openings 34 in a different linear position.

The cover member 42 may take on various configurations. For example, the cover member 42 may be a generally circular plate having an outer circumferential edge 44 and a series of spaced ribs 48 that define openings 58 between the ribs 48. The ribs 48 are symmetrically offset from the slotted openings 34 in the base member 20 such that in the closed position of the cover member 42, the ribs 48 are aligned with and disposed over the openings 34 to block airflow through the openings. The cover member 42 may be fully opened by the rider rotating the cover about 180° such that the ribs 48 are aligned with and spaced between the openings 58 in the base member 20. Thus, in the open position, the openings 34 are at least partially uncovered and airflow through the vent assembly 21 is permitted. In a position of the cover member 42 that is less than fully open, the ribs 48 are oriented with a transverse component with respect to the openings 34 in the base member 20 and define a grid-like pattern that may also function as a screen to bugs, road debris, and the like.

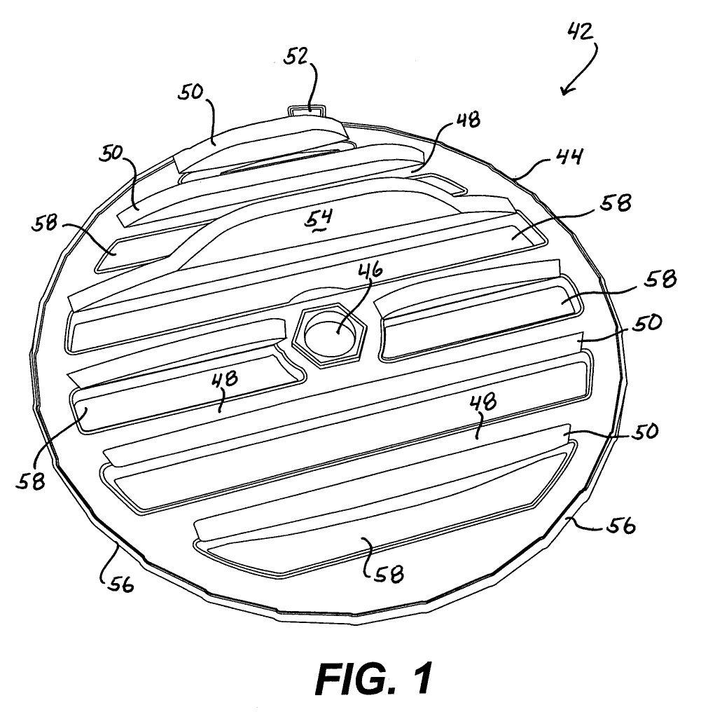

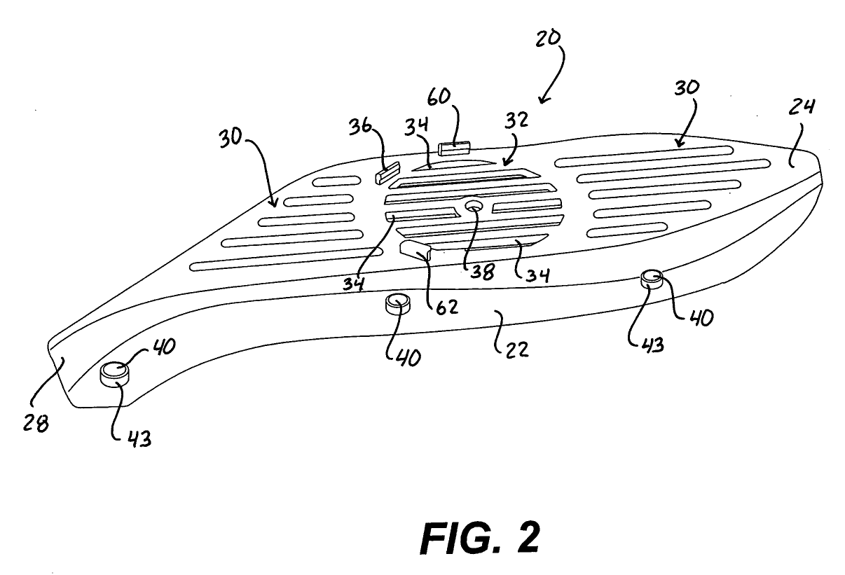

The open and closed rotational positions of the cover member 42 may be preferably positively defined by mechanical stops. For example, referring particularly to FIGS. 1 and 2, the cover member 42 may include a stop tab 52 defined at a certain position along its circumferential edge 44. This stop tab 52 engages against a first structural stop 60 provided on the base member 20 at the fully open position of the cover member 42, as illustrated in FIG. 5. The stop tab 52 abuts against a second structural stop 62 provided on the base member 20 at the fully closed position of the cover member 42, as illustrated in FIG. 6. The stops 60, 62 may also have a lip that extends over the cover member 42 and thus also serve to structurally retain the cover member 42 relative to the base member 20. One or more additional guide tabs 36 may be provided on the base member 20 to further support and retain the cover member 42.

It may be desirable to provide the capability to rotationally direct airflow through the wing assembly 10. This may be accomplished by providing louvers or other directional structure to the vent assembly 21. In the illustrated embodiment, the ribs 48 in the cover member 42 have a respective upper angled component 50 that collectively act as a series of deflecting members such that the direction of air flow through the vent passage 32 is varied by the rotational position of the cover member 42.

In a desirable embodiment, the vent assembly 21 is variably positionable between the fully open position of FIG. 5 and fully closed position of FIG. 6 such that the volume of air flow through the vent passage 32 may be varied. This may be accomplished by various means. In the illustrated embodiment, the cover member 42 may be frictionally engaged with the stops 60, 62 and additional guide 36, or any other structure of the base member 20, such that free rotation of the cover member 42 is inhibited. The cover member 42 may be positioned by the rider to a desired position and held in this position by frictional engagement between the components. In an alternate embodiment, the cover member 42 may be variably positionable between defined rotational positions. For example, the circumferential edge 44 of the cover member may be scalloped with recesses 56 around the edge 44, with the recesses being engaged by the stops 60, 62 and guide tab 36. Each recess 56 thus defines a different rotational position of the cover member 42. In an alternate embodiment, bumps around the cover member 42 may releasably engage in divots defined in the base member 20, and so forth. Any suitable releasable engagement configuration between the cover member 42 and base member 20 may be utilized in this regard.

As mentioned, it is desirable that the cover member 42 be easily movable by the rider. In this regard, a finger grip member 54 may be provide on the cover member 42 to allow for manual grasping and rotation of the cover member 42.

It should be appreciated by those skilled in the art that various modifications and variations may be made to the embodiment of the vented wing assembly illustrated and described herein without departing from the scope and spirit of the invention as set forth in the appended claims.

What is claimed is:

1. A vented extension assembly for a motorcycle fairing, comprising:
a base member having an attachment edge with a shape for complimentary attachment along an edge of a faring; and
a vent assembly configured in said base member, said vent assembly positionable between a closed position wherein airflow through said vent assembly is blocked, and an open position wherein airflow is directed through said vent assembly.

2. The assembly as in claim 1, wherein said vent assembly comprises a vent passage through said base member, and a cover member movably mounted to said base member, said cover positionable between said closed position and open position.

3. The assembly as in claim 2, wherein said cover member is rotatably mounted to said base member relative to an axis located at a center of said vent passage.

4. The assembly as in claim 2, wherein said vent passage comprises a series of openings defined through said base member, said cover member having a configuration to cover said openings in said closed position.

5. The assembly as in claim 4, wherein said cover member comprises a series of spaced ribs that cover said openings in said closed position, and move to a position to uncover said openings in said open position.

6. The assembly as in claim 5, wherein said ribs are aligned with and disposed over said openings in said closed position, and aligned with and spaced between said openings in a fully open position of said cover member.

7. The assembly as in claim 1, wherein said vent assembly is variably positionable between said closed and open positions.

8. The assembly as in claim 2, wherein said cover member is variably positionable between a first rotational position corresponding to said closed position and a second rotational position corresponding to said open position.

9. The assembly as in claim 8, further comprising a plurality of defined open positions of said cover member between said first and second rotational positions.

10. The assembly as in claim 2, further comprising a first stop member disposed to define said closed position of said cover member, and a second stop member disposed to define said open position of said cover member.

11. The assembly as in claim 2, further comprising a finger grip member configured on said cover to allow for manual grasping and rotation of said cover member.

12. The assembly as in claim 2, further comprising a frictional sliding engagement between said cover member and said base member such that said cover member is variably positionable between said open and closed positions and maintained in said positions by said frictional engagement.

13. The assembly as in claim 2, further comprising a plurality of mechanical engagement positions disposed at distinct locations between said cover member and said base member such that said cover member is variably positionable between said open and closed positions and maintained in any one of said mechanical engagement positions.

14. The assembly as in claim 2, wherein said cover member is rotationally mounted to said base member and comprises angled deflecting members, said deflecting members directing airflow through said vent assembly in a desired direction as a function of the rotational position of said cover member relative to said base member.

15. A motorcycle fairing, comprising:
a body configured for attachment to a motorcycle, said body having side edges;
a pair of wing extensions releasably attachable to said body along opposite said side edges, each of said wing extensions further comprising;
a base member having an attachment edge with a shape for complimentary attachment along said one of said fairing side edges; and
a vent assembly configured in said base member, said vent assembly positionable between a closed position wherein airflow through said vent assembly is blocked, and an open position wherein airflow is directed through said vent assembly.

16. The fairing as in claim 15, wherein said vent assembly comprises a vent passage through said base member, and a cover member movably mounted to said base member, said cover positionable between said closed position and open position.

17. The fairing as in claim 16, wherein said cover member is rotatably mounted to said base member relative to an axis located at a center of said vent passage.

18. The faring as in claim 16, wherein said vent passage comprises a series of openings defined through said base member, said cover member comprising a series of spaced ribs that cover said openings in said closed position, and move to a position to uncover said openings in said open position.

19. The fairing as in claim 18, wherein said ribs are in a generally transverse position to said openings in an open position that is less than fully open such that a grid pattern is defined by said openings in said base member and said ribs.

20. The fairing as in claim 15, wherein said vent assembly is variably positionable between said closed and open positions.

21. The fairing as in claim 16, wherein said cover member is variably positionable between a first rotational position corresponding to said closed position and a second rotational position corresponding to said open position, an further comprising stops disposed at said open and closed positions to limit relative movement between said cover member and said base member.

22. The fairing as in claim 21, wherein said cover member is in sliding frictional engagement with said base member between said open and closed positions.

23. The fairing as in claim 21, further comprising a plurality of mechanical engagement positions disposed at distinct locations between said cover member and said base member such that said cover member is variably positionable between said open and closed positions and maintained in any one of said mechanical engagement positions.

24. The fairing as in claim 16, further comprising a finger grip member configured on said cover to allow for manual grasping and rotation of said cover member.

25. The fairing as in claim 16, wherein said cover member further comprises angled deflecting members.
